(19) United States
(12) Patent Application Publication
(10) Pub. No.: US 2016/0129877 A1
(43) Pub. Date: May 12, 2016

(54) BUCKLE GUIDE

(71) Applicant: Ford Global Technologies, LLC, Dearborn, MI (US)

(72) Inventors: Brian Robert Spahn, Plymouth, MI (US); Benjamin Yilma, Canton, MI (US)

(73) Assignee: FORD GLOBAL TECHNOLOGIES, LLC, Dearborn, MI (US)

(21) Appl. No.: 14/535,400

(22) Filed: Nov. 7, 2014

(51) Int. Cl. B60R 22/18; A44B 11/25

(52) U.S. Cl. CPC B60R 22/18; A44B 11/2592; B60R 2022/1812

(57) ABSTRACT

A guide mechanism may be provided in a buckle assembly including an inner sleeve and an outer sleeve. The guide mechanism in one example includes notches in the outer sleeve mateable to notches in a tongue piece. In another example, the guide mechanism includes ribs formed on an interior of the outer sleeve, that together with a wall of an outer button included in the outer sleeve, form a slot for receiving a tongue piece. In yet another example, the guide mechanism includes a pair of leaf springs having openings therein forming a slot for receiving a tongue piece.

### BACKGROUND

Vehicle occupants can have difficulty in accessing and securing seatbelt buckles. Safety needs usually dictate the use of a short buckle to minimize seatbelt slack and encourage early and stiff engagement of the seatbelt on the pelvis. Unfortunately, while best for safety performance, a short buckle is typically difficult to locate and align with a seatbelt tongue while a vehicle occupant is donning the seatbelt. Although electric seatbelt buckle presenters can improve buckle accessibility, these systems are very expensive and therefore not practical for all but a few luxury vehicles. Accordingly, a seatbelt buckle system having improved accessibility is needed.

### DRAWINGS

FIG. 1 is a perspective view of a first example of a buckle system.

FIG. 2 is a side cross-sectional view of a second example of a buckle system.

FIG. 3 is a top view of the buckle system of FIG. 2.

FIG. 4 is a perspective view of a third example of a buckle system.

FIG. 5 is a top view of the buckle system of FIG. 4.

FIG. 6 is a perspective view of an exemplary buckle assembly including a tensioning mechanism.

FIG. 7 is a side cross-sectional view of the buckle assembly of FIG. 6 including the tensioning mechanism.

FIG. 8 is a partial top cross-sectional view of the buckle assembly of FIG. 6 including the tensioning mechanism.

FIGS. 9A and 9B are perspective views of receiving assemblies including respective exemplary outer buttons for releasing buckle.

### DESCRIPTION

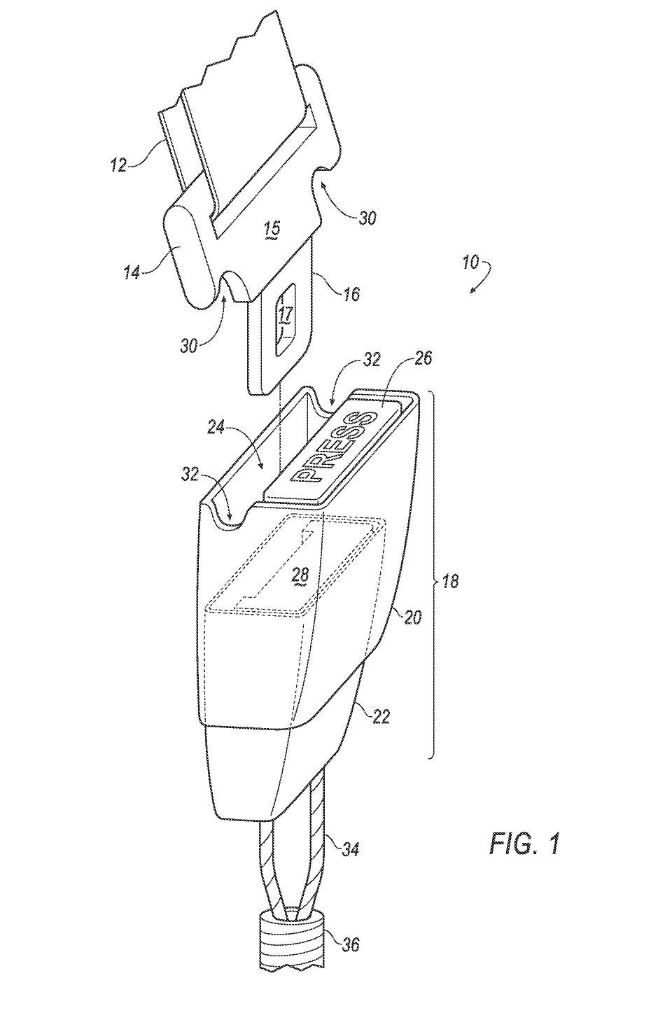

Disclosed herein are mechanisms for guiding a tongue into a buckle. FIG. 1 is a perspective view of a buckle system 10. A seatbelt 12 is secured to a tongue piece 14 in a conventional manner. The tongue piece 14 includes a conventional latch plate 16 having a latch opening 17 that may be used to secure the tongue 14 to a buckle in a known manner. A receiving assembly includes an outer sleeve 20 mounted over an inner sleeve 22. Components described herein are generally made of known materials in a known manner, e.g., the sleeves 20, 22 may be formed of molded plastic or the like, the tongue piece 14 may include metal and/or plastic, e.g., the latch plate 16 may be formed of metal, etc.

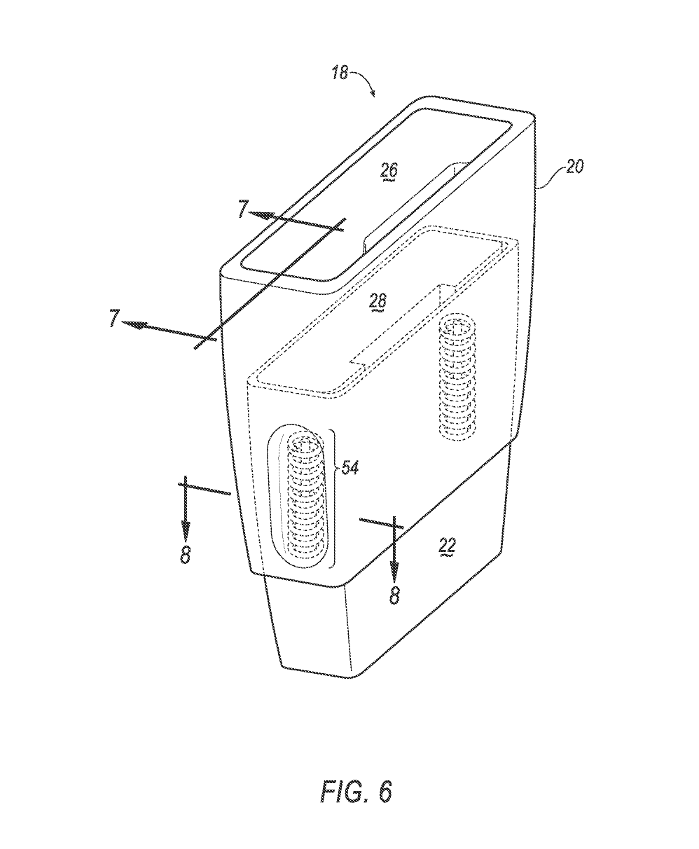

The sleeve 22 serves as a cover for a buckle mechanism, not shown inasmuch as the buckle mechanism is known for receiving and securing the latch plate 16, as just mentioned. The sleeve 22 may receive a tether 34 that is attached to an anchor 36 in a known manner at a first end, and to a buckle mechanism at a second end. An outer button 26, secured to the outer sleeve 20, may contact an inner button 28 that is secured to the inner sleeve 22 for releasing the buckle mechanism after the latch plate 16 has been secured. As described further below with respect to FIGS. 6-8, springs and/or dampers may be provided in the receiving assembly 18 to tension the outer sleeve 20 with respect to the inner sleeve 22, and/or to urge the outer sleeve 20 upward with respect to the inner sleeve 22. For example, such tensioning may cause a top side of the outer sleeve 20 to be urged away from a top side of the inner sleeve 22, in a controlled manner when the buttons 26, 28 are depressed to release the latch plate 16 from the buckle mechanism.

The outer sleeve 20 includes a receiving slot 24 for receiving the latch plate 16. Note that a spring loaded door or other known mechanism could be provided to cover the slot 24 to prevent contaminants from entering the slot 24 when the tongue 16 is not inserted in the slot 24. Notches 30 are provided on the tongue piece 14, the notches 30 being arranged to be received by notches 32 included in sides of the outer sleeve 20 such that the notches 30, 32 are a guide mechanism. For example, the notches 30 may be formed in a side of the tongue piece 14 facing in a direction in which the tongue latch plate 16 extends, and in a plane substantially defined by an upper portion 15 of the tongue piece 14. Further, the notches 32 may be formed in planes defined by sides of the outer sleeve 20 such that planes of the notches 30 and 32, respectively, are substantially perpendicular to one another. In addition, the sides of the outer sleeve 20 and/or planes thereof including the notches 32 are substantially perpendicular to a longitudinal axis of the slot 24. Moreover, the notches 30, 32 may be curved, e.g., substantially semi-circular, in shape. However, other shapes, e.g., half-rectangles or the like, are possible; the notches 30, 32 should generally be configured to be interlocking. Thus, when a vehicle occupant inserts the tongue piece 14 into the receiving slot 24, edges of the notches 30, 32 may contact each other and serve to guide the tongue piece 14, including the latch plate 16, and to provide alignment of the plate 16 in the slot 24 for securing by the buckle mechanism.

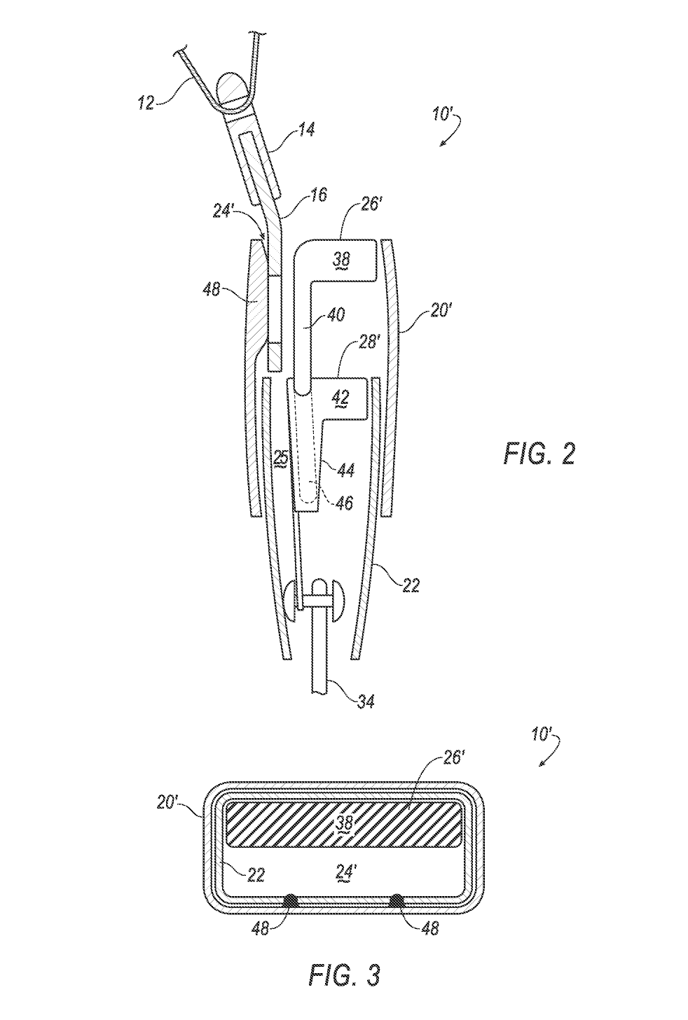

FIG. 2 is a side-cross-sectional view of a second example of a buckle system 10′, and FIG. 3 is a top view of the buckle system of FIG. 2. As can be seen, in these figures the system 10′ includes like elements discussed above with respect to the system 10; such elements need not be described again with respect to the system 10′.

Further, the system 10′ includes an outer sleeve 20′ that surrounds the inner sleeve 22. The sleeve 20′ has a plurality longitudinal ribs 48 formed on an interior surface of the sleeve 20′, and extending substantially from a top edge of the interior surface of the sleeve 20′ to a location that is generally one-third to one-half the longitudinal distance of the sleeve 20′. In general, a length of the ribs 48 is selected to be sufficient to guide the latch plate 16 in a receiving slot 24′ as described further below; the ribs 48 generally end at or before a point where the outer sleeve 20′ overlaps the inner sleeve 22.

An outer button 26′ is disposed in the sleeve 20′ above and inner button 28′, the inner button 28′ being disposed in the sleeve 22. The outer button 26′ is generally L-shaped, including a lateral portion 38 and a descending portion 40. The inner button 28′ is also generally L-shaped, having a lateral portion 42 and a descending portion 44. The descending portion 44 of the inner button 28′ includes a receiving slot 46 for receiving the descending portion 40 of the outer button 26′. After a buckle mechanism disposed in the inner sleeve 22 has secured the latch plate 16, the outer button 26′ may be pressed downward to contact the inner button 28′, which in turn may be urged downward to release the latch plate 16 from the buckle mechanism (not shown because the buckle mechanism is known and operates with the latch plate 16 in a conventional manner).

As mentioned above, the system 10′ includes a receiving slot 24′ for receiving the latch plate 16. The receiving slot 24′ is defined by the ribs 48 and a side of the descending portion 40 of the outer button 26′ that faces the ribs 48. Thus, when the tongue piece 14 including the latch plate 16 is inserted into the slot 24′, the ribs 48 serve to guide the latch plate 16 into a buckle slot 25 in the inner sleeve 22. The buckle slot 25 is generally defined by an interior surface of the buckle sleeve 22 and a face of the descending portion 44 of the inner button 28′. When a vehicle occupant is attempting to buckle a seatbelt, the receiving slot 24′, including the ribs 48, serves to guide the tongue latch plate 16 toward the buckle slot 25, and the buckle slot 25 serves to guide the latch plate 16 toward the buckle mechanism used to secure the latch plate 16, whereby the ribs 48 and the descending portion 44 are a guide mechanism.

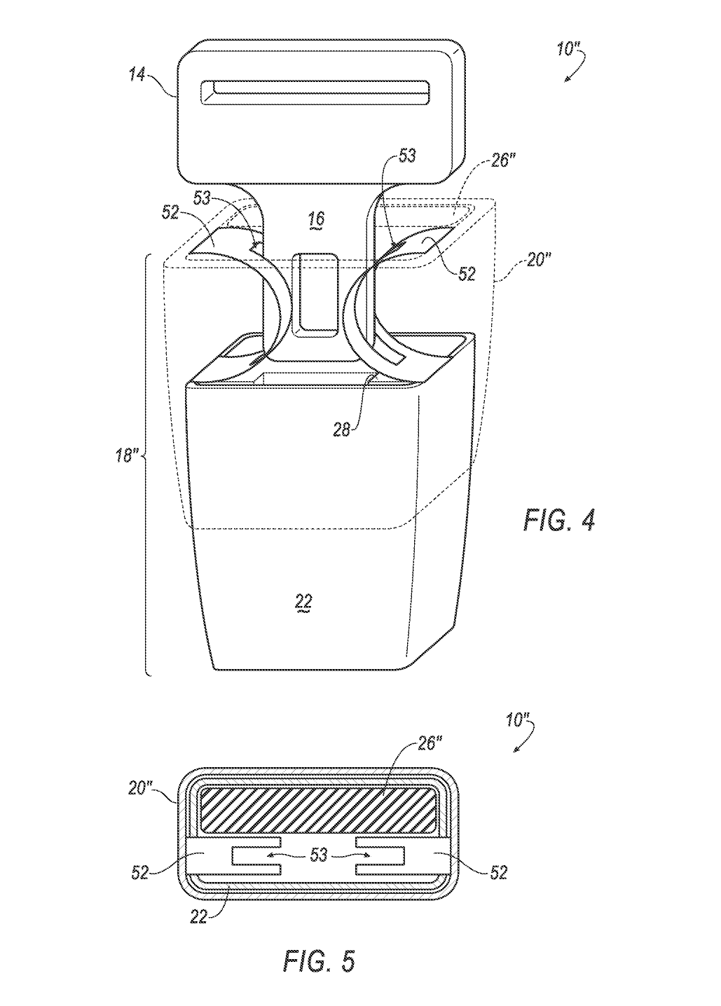

FIG. 4 is a perspective view of a third example of a buckle system 10″. FIG. 5 is a top view of the buckle system 10″. Again, like elements discussed above with respect to the system 10 need not be described again with respect to the system 10″. As can be seen in FIG. 4, and outer sleeve 20″ has disposed therein a pair of leaf springs 52 that each include an opening 53. The leaf springs 52 are generally secured to a top side edge of the outer sleeve 20″ at a first end, with a second end resting on an inner button 28 attached to the inner sleeve 22. The leaf springs 52 generally have a width extending from a front interior surface of the sleeve 20″ to a side of an outer button 26″.

The outer sleeve 20″ may be secured to the inner sleeve 22 such that the openings 53 of the leaf springs 52 form slots for receiving the tongue latch 16 even when the buckle assembly 18″ is in a relaxed position, i.e., the buckle mechanism in the inner sleeve 22 is not securing the tongue latch 16, and the outer sleeve 20″ is urged away from the inner sleeve 22, e.g., by the leaf springs 52. Accordingly, slots formed in the openings 53 serve to guide the tongue latch plate 16 toward the buckle mechanism, for example, facilitating buckling a seatbelt for a vehicle occupant, whereby the leaf springs 52 including the openings 53 are a guide mechanism for the tongue latch plate 16.

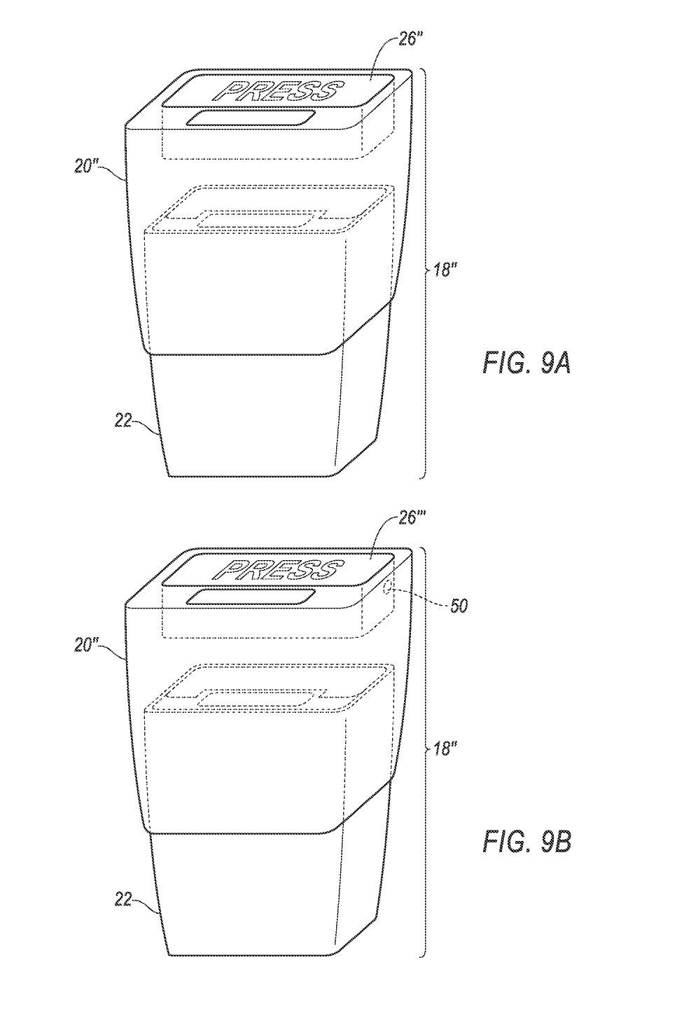

As seen in FIG. 9A, an outer button 26″ included in the outer sleeve 20″of an assembly 18″may be secured to the outer sleeve 20″ in a fixed manner. Accordingly, when the button 26″ is pressed, urging the outer sleeve 20″ toward the inner sleeve 22, the button 26″ moves downward until it contacts the inner button 28, which in turn causes a buckle mechanism to release the tongue latch 16. In a variation seen in FIG. 9B, a movable outer button 26″′ included in the outer sleeve 20″ may be pivotably affixed to the outer sleeve 20″, e.g., using a pin 50 or other mechanism allowing the button 20″ to pivot with respect to the outer sleeve 20″. The button 26′″ may have an angled or curved bottom side such that pivoting the button 26″′, possibly in conjunction with pressing downward toward the inner sleeve 22, contacts and causes depression of the inner button 26. Alternatively or additionally, the moveable button 26′″ may be provided with a vertical translation, e.g., at an axis defined by a pin or pins 50 such that the button 26′″ may be moved up and down with respect to the outer sleeve 20″to effect contact with the inner button 28.

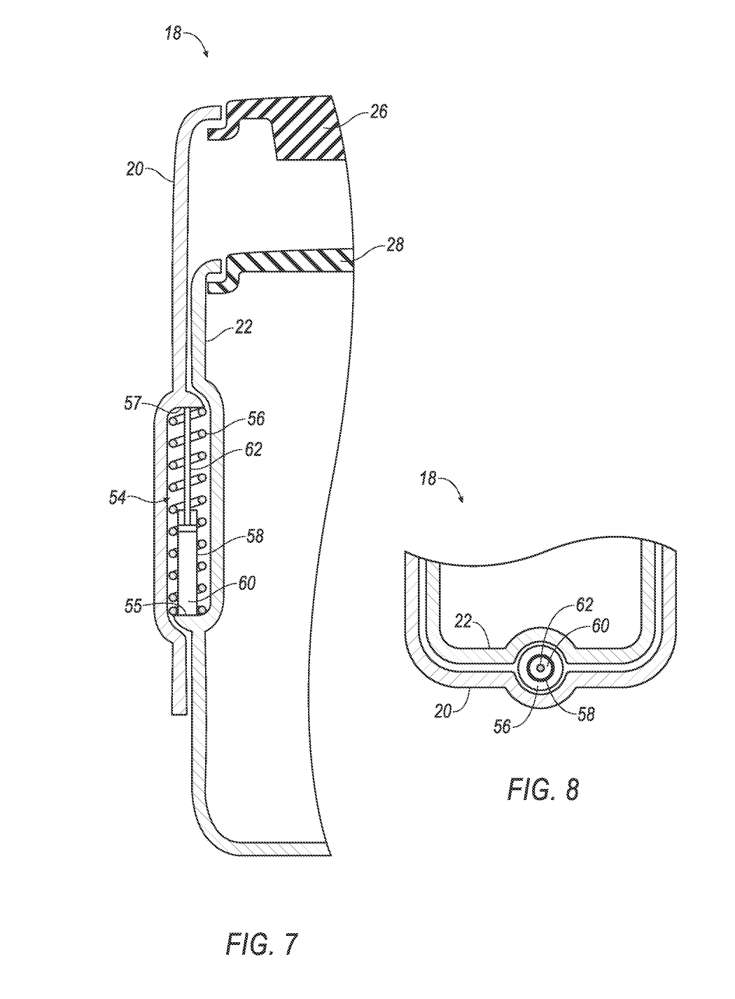

As mentioned above, the buckle assemblies 18, 18′, 18″, may include a mechanism to urge apart the outer sleeve 20 and inner sleeve 22 as well as to damp the effect of releasing a tongue latch 16 from a buckle mechanism. FIG. 6 is a perspective view of a buckle assembly 18 including an exemplary tensioning mechanism 54; FIG. 7 shows a side cross-sectional view, and FIG. 8 shows a top cross-sectional view. The tensioning mechanism 54 includes a coil spring 56 disposed between a shelf 55 that may be formed in a side wall of the inner sleeve 22, and a facing shelf 57 that may be formed in a side wall of the outer sleeve 20. A damper 58 including a damper cylinder 60 and a piston 62 is disposed within the coil spring 56. The damper 58 may use a variety of known mechanisms, e.g., the cylinder 60 may operate via friction, pneumatic, or oil-filled damping.

When an outer button 26 is pressed and thus urged toward the inner button 28, carrying with it the outer sleeve 20 moving with respect to the inner sleeve 22, the coil spring 56 which provides tension urging the buttons 26, 28 apart, is compressed. The coil spring 56 remains in a compressed state when the latch 16 is secured by a buckle mechanism. However, when the buckle mechanism is released, the coil spring 56 decompresses, urging the buttons 26, 28 apart, i.e., moving the outer sleeve 20 in a direction away from the buckle mechanism with respect to the inner sleeve 22. The damper 58 is provided to reduce the suddenness and/or force with which the outer sleeve 20 moves, thereby avoiding startling or annoying a vehicle occupant releasing a buckle.

As used herein, the adverb “substantially” means that a shape, structure, measurement, quantity, time, etc. may deviate from an exact described geometry, distance, measurement, quantity, time, etc., because of imperfections in materials, machining, manufacturing, etc.

In the drawings, the same reference numbers indicate the same elements. Further, some or all of these elements could be changed. With regard to the components, processes, systems, methods, etc. described herein, it should be understood that these are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A buckle system, comprising:
a tongue piece including a first pair of notches facing a latch plate;
an outer sleeve and an inner sleeve, the outer sleeve fittable over the inner sleeve and including a second pair of notches; and
a slot defined in the outer sleeve to receive the latch tongue plate and having a longitudinal axis that is substantially perpendicular to the second pair of notches.

2. The system of claim 1, wherein each of the notches is one of curved and rectangular.

3. The system of claim 1, further comprising an outer button mounted on the outer sleeve and an inner button mounted on the inner sleeve.

4. The system of claim 1, further comprising a tensioning mechanism for urging a top side of the outer sleeve away from a top side of the inner sleeve.

5. The system of claim 4, wherein the tensioning mechanism includes a damping mechanism.

6. The system of claim 1, further comprising a seat belt connected to the tongue piece.

7. A buckle system, comprising:
an inner sleeve;
an outer sleeve, the outer sleeve fittable over the inner sleeve and having a plurality of ribs formed on an interior surface thereof;
an L-shaped outer release button disposed in the outer sleeve and having a descending portion; and
an L-shaped inner release button disposed in the inner sleeve and including an inner button descending portion having a slot configured to receive the outer button descending portion;
wherein a slot is defined by the ribs and a wall of the outer release button.

8. The system of claim 7, wherein the ribs have a length that is substantially one-third to one-half a length of the outer sleeve.

9. The system of claim 7, further comprising a tongue piece including a tongue latch plate configured to be received by the slot.

10. The system of claim 7, further comprising a tensioning mechanism for urging a top side of the outer sleeve away from a top side of the inner sleeve.

11. The system of claim 10, wherein the tensioning mechanism includes a damping mechanism.

12. The system of claim 7, further comprising a tongue piece and a seat belt connected to the tongue piece.

13. A buckle system, comprising:
an outer sleeve and an inner sleeve, the outer sleeve fittable over the inner; and
a pair of leaf springs, each of the leaf springs being attached at a top edge to a top edge of the outer sleeve, and having a bottom edge resting on a top side of the inner sleeve,
respective openings defined in each of the leaf springs, wherein the openings form a slot for receiving a tongue piece when the leaf springs are compressed.

14. The system of claim 13, further comprising an outer button mounted on the outer sleeve and an inner button mounted on the inner sleeve.

15. The system of claim 14, wherein the outer button is fixedly mounted on the outer sleeve.

16. The system of claim 14, wherein the outer button is pivotably mounted on the outer sleeve.

17. The system of claim 14, wherein the outer button is slidably mounted on the outer sleeve.

18. The system of claim 13, further comprising a tensioning mechanism for urging a top side of the outer sleeve away from a top side of the inner sleeve.

19. The system of claim 18, wherein the tensioning mechanism includes a damping mechanism.

20. The system of claim 13, further comprising a seat belt connected to the tongue piece.
